(19) United States
(12) Patent Application Publication
(10) Pub. No.: US 2004/0125693 A1
(43) Pub. Date: Jul. 1, 2004

(54) Food processing device driven by one single motor

(75) Inventor: Mete Gursel, Avcilar/Istanbul (TR)

Correspondence Address: John S. Egbert, Harrison& Egbert, 7th Floor, 412 Main Street, Houston, TX, 77002, US

(73) Assignee: ERNA-MAS MAKINE TICARET VESANA YI ANONIM SIRKETI, Avcilzr/Istanbul (TR)

(21) Appl. No.: 10/647,199

(22) Filed: Aug. 25, 2003

(30) Foreign Application Priority Data
Dec. 26, 2002 (TR) U 2002 02731

(51) Int. Cl. B01F 13/04

(52) U.S. Cl. 366/601; 99/486

(57) ABSTRACT

Present invention relates to a food processing device driven by one single motor and used at the sites of food preparation, characterized in that onto the motor block of kitchen robot (1-1), an elastic, twistable and extendable-shrinkable (flexible) motion transfer element (1-4) that is attached via a detachable sleeve group (1-3) is provided and any special functioning accessory (1-5) are actuated through control of a working speed specific to the relevant function via a speed adjustment switch (1-2) present on the motor block.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

Present invention relates to a food processing device driven by one single motor and used at the sites of food preparation, characterized in that onto the motor block of a kitchen robot (1-1), an elastic, twistable and extendable-shrinkable (flexible) motion transfer element (1-4) that is attached via a detachable sleeve group (1-3) is provided and any special functioning accessory (1-5) is actuated through control of a working speed specific to the relevant function via a speed adjustment switch (1-2) present on the motor block.

### BACKGROUND OF THE INVENTION

The currently used processing devices are of two types:

1—The device type operated by adding foodstuffs into the device for processing purposes (e.g. Kitchen robot); and

2—The device type operated by placing the devices into food containers for processing purposes (e.g. Hand mixers, hand blenders).

The present invention allows performance of both operations as indicated above for two different types of food processing devices, in a more practical and compact way, through use of a device driven by one single motor.

Present invention is based on the fact that all food processing operations are performed via a device driven by one single motor.

### BRIEF SUMMARY OF THE INVENTION

Present invention relates to the field of electrical household tools described in general under the name of kitchen robots (1) and used at food processing locations such as kitchens, etc.

### BRIEF DESCRIPTION OF THE VIEW OF THE DRAWING

FIG. 1: Components of Food Processing Device Driven by One Single Motor

FIG. 2: Hand blender operations,

FIG. 3: Formed cookies application,

FIG. 4: Hand mixer (high powerful) operation

FIG. 5: Washbasin and dishing brush operations

FIG. 6: Can opening operations

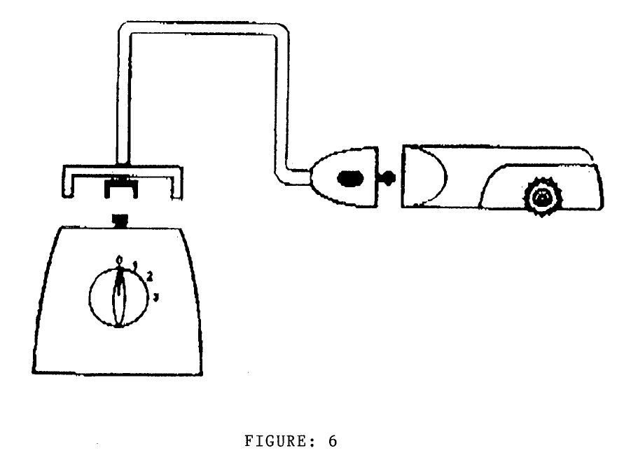

FIG. 7: Bread cutting operations

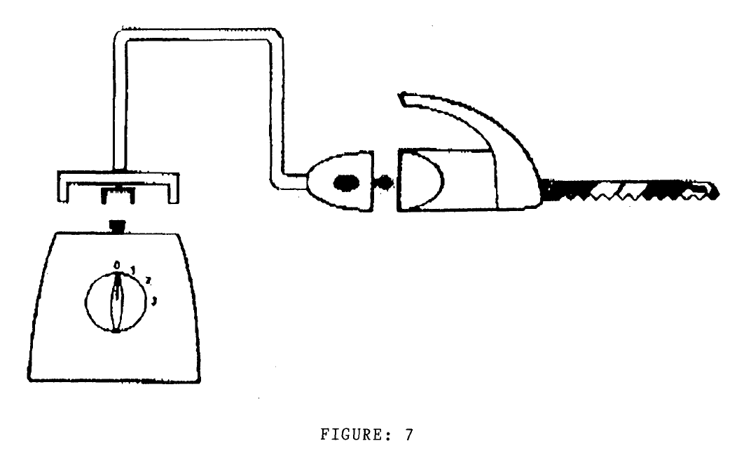

FIG. 8: Food chopping/cutting/breaking into pieces operations.

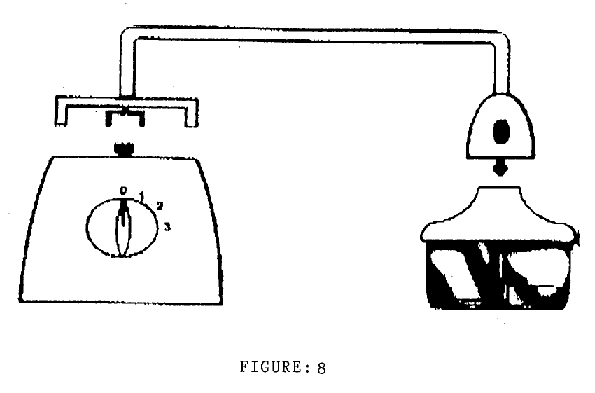

### DETAILED DESCRIPTION OF THE INVENTION

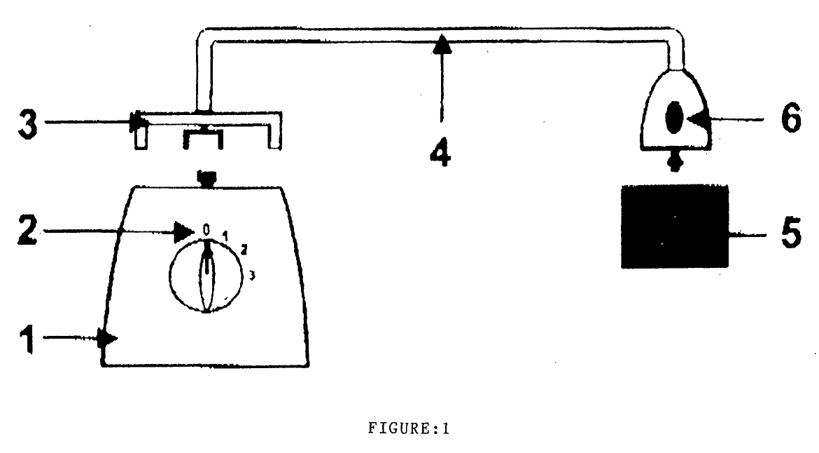

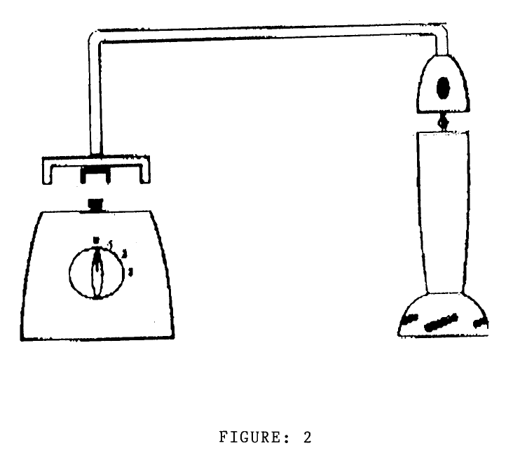

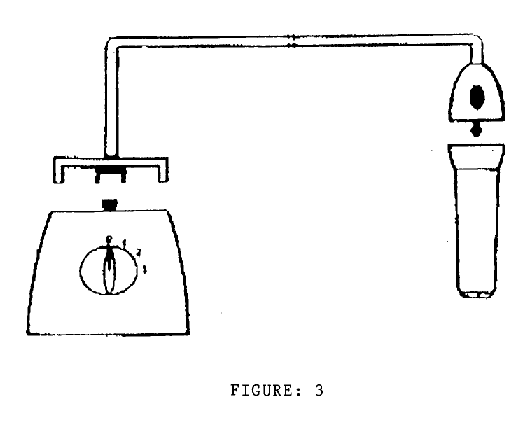

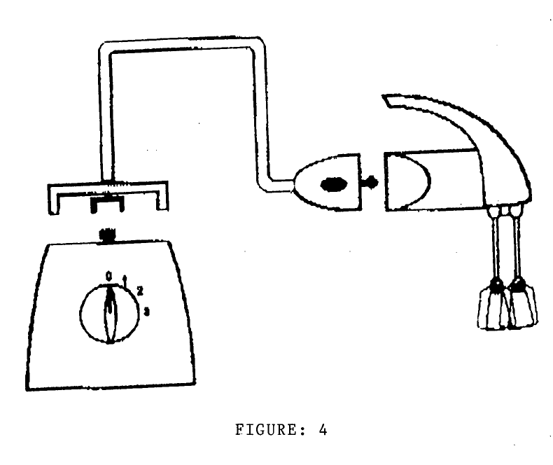

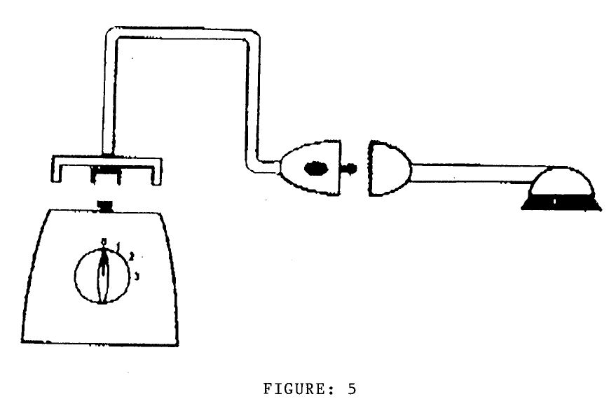

According to present invention, onto the motor block of a kitchen robot, a flexible (elastic, twistable and extendable-shrinkable) motion transfer element (FIG. 1-4) that is attached via a detachable sleeve group (1-3) is provided and through which any special functioning accessory (FIG. 1-5) is actuated.

A working speed specific to the relevant function is obtained via a speed adjustment switch (1-2) present on the motor block. An extra on/off switch (1-6) is present on the accessory to switch the same on or off.

The description of a special functioning accessory is also covered by present invention.

With the use of present invention, it is possible to carry out a hand blender operation (2), a formed cookies application (3), hand mixer (high powerful) operation (4), washbasin and dishing brush operations (5), can opening operations (6), bread cutting operations (7) and food chopping/cutting/breaking into pieces operations (8).

I claim:

1. A food processing device driven by one single motor and used at the sites of food preparation, characterized in that onto the motor block of kitchen robot (1-1), an elastic, twistable and extendable-shrinkable (flexible) motion transfer element (1-4) that is attached via a detachable sleeve group (1-3) is provided and any special functioning accessory (1-5) are actuated through control of a working speed specific to the relevant function via a speed adjustment switch (1-2) present on the motor block.

2. A food processing device driven by one single motor according to claim 1 characterized in that all of the operations as indicated for all types of currently used food processing devices are performed in a more practical and compact way, through use of a device driven by one single motor.

3. A food processing device driven by one single motor according to claim 1 characterized in that the functions of electrical household tools described in general under the name of kitchen robots (1) and used at food processing locations such as kitchens, etc. are performed.

4. A food processing device driven by one single motor according to claim 1 characterized in that onto the motor block of kitchen robot, a flexible (elastic, twistable and extendable-shrinkable) motion transfer element (FIG. 1-4) that is attached via a detachable sleeve group (1-3) is provided and through which any special functioning accessory (FIG. 1-5) is actuated.

5. A food processing device driven by one single motor according to claim 1 characterized in that a working speed specific to the relevant function is obtained via a speed adjustment switch (1-2-) present on the motor block.

6. A food processing device driven by one single motor according to claim 1 characterized in that an extra on/off switch (1-6) is present on the accessory to switch the same on or off.

7. A food processing device driven by one single motor according to claim 1 characterized in that it makes possible to carry out a hand blender operation, a formed cookies application, hand mixer (high powerful) operation, washbasin and dishing brush operations, can opening operations, bread cutting operations and food chopping/cutting/breaking into pieces operations.
